(19) United States
(12) Patent Application Publication
(10) Pub. No.: US 2023/0369680 A1
(43) Pub. Date: Nov. 16, 2023

(54) Thermal regulation of a battery by immersion in a liquid composition

(71) Applicant: ARKEMA FRANCE, Colombes (FR)

(72) Inventors: Dominique GARRAIT, Pierre-Benite Cedex (FR); Laurent ABBAS, Pierre-Benite Cedex (FR)

(73) Assignee: ARKEMA FRANCE, Colombes (FR)

(21) Appl. No.: 18/246,546

(22) PCT Filed: Oct. 1, 2021
(86) PCT No.: PCT/FR2021/051702

§ 371 Date: Mar. 24, 2023

(30) Foreign Application Priority Data
Oct. 19, 2020 (FR) FR2010703
May 18, 2021 (FR) FR2105145

(51) Int. Cl. H01M 10/6568; H01M 10/617; H01M 10/625; H01M 10/663

(52) U.S. Cl. CPC H01M 10/6568; H01M 10/617; H01M 10/625; H01M 10/663; H01M 2220/20

(57) ABSTRACT

The use of a heat-transfer composition including from more than 0% to 40% by weight of a refrigerant including a compound chosen from halogenated hydrocarbons, perhalogenated compounds, fluorinated ketones, fluorinated ethers and the combinations thereof, and from 60% to less than 100% by weight of a dielectric fluid, in order to regulate the temperature of a battery, the battery including energy storage cells immersed in the heat-transfer composition in the liquid state, and the heat-transfer composition undergoing essentially no change of state.

### FIELD OF THE INVENTION

The present invention relates to the use of a heat-transfer composition comprising at least one refrigerant and at least one dielectric fluid, for regulating the temperature of a battery. The invention applies in particular to the batteries of electric or hybrid vehicles.

### TECHNICAL BACKGROUND

The need to dissipate high heat fluxes is essential in several applications, in particular the cooling of batteries.

In particular, the batteries in electric or hybrid vehicles give maximum efficiency under specific working conditions and especially within a quite specific temperature range. Thus, in cold climates, the range of electric or hybrid vehicles is a problem, all the more so since the high heating requirements consume a large proportion of the stored electrical energy. In addition, at low temperatures, the available power of the battery is low, which presents a driving problem. Moreover, the cost of the battery contributes significantly toward the cost of the electric or hybrid vehicle.

Conversely, cooling of the battery is a major safety issue. Various dielectric oils may be used to cool the battery of an electric or hybrid vehicle. However, when fast charging of the battery is required, the use of dielectric oils alone is not sufficient to effectively cool the battery. In this case, more volatile and less viscous fluids need to be used. However, these fluids usually have higher vapor pressures than those observed in the case of dielectric oils, which may require reinforcement of the battery casing (and thus an increase in its weight) in order to withstand the pressure. These fluids are moreover more expensive than dielectric oils.

Furthermore, it is important to use compositions that are only slightly flammable or non-flammable in the vicinity of the battery so as to eliminate any safety risks associated with the use of these compositions.

Document FR 2973809 relates to the use of a zeolite adsorbent for improving the thermal stability of an oil subjected to temperature variations in coolant fluid compositions.

Document FR 2962442 relates to a stable composition comprising 2,3,3,3-tetrafluoropropene, for use in refrigeration and air conditioning.

Document US 2014/057826 relates to a heat-transfer composition comprising at least one hydrochlorofluoroolefin used for air conditioning, refrigeration and heat pump applications or used for the cleaning of products, components, substrates or other articles containing the substance to be cleaned.

Document WO 2019/242977 relates to a fluid-insulated switchgear which comprises a fluid compartment filled with an electrically insulating fluid and an electrical conductor located in the fluid compartment and electrically insulated by the electrically insulating fluid.

Document WO 2019/162598 relates to the use of a refrigerant comprising 2,3,3,3-tetrafluoropropene for maintaining the temperature of a battery of an electric or hybrid vehicle within a temperature range.

Document WO 2019/162599 relates to the use of a refrigerant comprising 2,3,3,3-tetrafluoropropene for preheating a battery of an electric or hybrid vehicle when the vehicle is started.

Document WO 2019/197783 relates to a process for cooling and/or heating a body or a fluid in a motor vehicle, by means of a system comprising a vapor compression circuit in which a first heat-transfer composition circulates and a secondary circuit in which a second heat-transfer composition circulates.

Documents WO 2020/011888, WO 2020/100152, WO 2020/007954, US 9,865,907, US 10,784,545, FR 3037727, FR 3075471, FR 3085542, FR 3085545, FR 3085547, FR 3085556 and EP 3 499 634 describe systems for thermal regulation of batteries by direct contact with a fluid.

There is a need to ensure optimal operation of batteries, notably in electric or hybrid vehicles, so as to provide safe and efficient batteries having a long lifespan, without increasing the costs.

### SUMMARY OF THE INVENTION

The invention relates firstly to the use of a heat-transfer composition comprising from more than 0% to 40% by weight of a refrigerant comprising a compound chosen from halogenated hydrocarbons, perhalogenated compounds, fluorinated ketones, fluorinated ethers and the combinations thereof, and from 60% to less than 100% by weight of a dielectric fluid, in order to regulate the temperature of a battery, the battery comprising energy storage cells immersed in the heat-transfer composition in the liquid state, and the heat-transfer composition undergoing essentially no change of state.

In some embodiments, the heat-transfer composition circulates in a heat-transfer circuit.

In some embodiments, the battery comprises one or more modules each comprising an enclosure in which energy storage cells are arranged, the enclosure(s) forming part of the heat-transfer circuit.

In some embodiments, the heat-transfer circuit is thermally coupled to a secondary circuit containing an additional transfer composition.

In some embodiments, the secondary circuit is the air conditioning circuit of a vehicle; and/or is a reversible heat pump circuit.

In some embodiments, the refrigerant comprises or is 1-chloro-3,3,3-trifluoropropene, preferably in E form, or is a binary, preferably azeotropic, mixture of 1-chloro-3,3,3-trifluoropropene in Z form and of 1,1,1,2,3-pentafluoropropane, or of 1,1,1,4,4,4-hexafluorobut-2-ene in Z form and of 1,2-dichloroethylene in E form.

In some embodiments, the dielectric fluid is chosen from mineral dielectric oils, synthetic dielectric oils and vegetable dielectric oils, and preferably from aromatic hydrocarbons chosen from alkylbenzenes, alkyldiphenylethanes, alkylnaphthalenes, methylpolyarylmethanes and the combinations thereof, poly(α-)olefins and polyol esters.

In some embodiments, the use is for the cooling of the battery.

In some embodiments, the battery is the battery of an electric or hybrid vehicle, preferably of an electric or hybrid automobile.

In some embodiments, the use is implemented during the charging of the battery of the vehicle, the battery of the vehicle preferably being fully charged in a period of time of less than or equal to 30 min, and preferably of less than or equal to 15 min, starting from its full discharge.

The invention also relates to a battery assembly, in particular for an electric or hybrid vehicle, comprising one or more modules each comprising an enclosure arranged in which are energy storage cells immersed in a heat-transfer composition in the liquid state, the heat-transfer composition comprising from more than 0% to 40% by weight of a refrigerant comprising a compound chosen from halogenated hydrocarbons, perhalogenated compounds, fluorinated ketones, fluorinated ethers and the combinations thereof, and from 60% to less than 100% by weight of a dielectric fluid, and the battery assembly being configured so that the heat-transfer composition undergoes essentially no change of state in order to regulate the temperature of the battery.

In some embodiments, the assembly comprises a heat-transfer circuit in which the heat-transfer composition circulates, the enclosure(s) of the module(s) being incorporated in this heat-transfer circuit.

In some embodiments, the heat-transfer circuit comprises a pump; and/or the heat-transfer circuit comprises a heat exchanger in order to enable a heat exchange between the heat-transfer composition and either the ambient air or a heat-transfer composition in a secondary circuit.

In some embodiments, the refrigerant comprises or is 1-chloro-3,3,3-trifluoropropene, preferably in E form, or is a binary, preferably azeotropic, mixture of 1-chloro-3,3,3-trifluoropropene in Z form and of 1,1,1,2,3-pentafluoropropane, or of 1,1,1,4,4,4-hexafluorobut-2-ene in Z form and of 1,2-dichloroethylene in E form.

In some embodiments, the dielectric fluid is chosen from mineral dielectric oils, synthetic dielectric oils and vegetable dielectric oils, and preferably from aromatic hydrocarbons chosen from alkylbenzenes, alkyldiphenylethanes, alkylnaphthalenes, methylpolyarylmethanes and the combinations thereof, poly(α-)olefins and polyol esters.

The invention also relates to a method for regulating the temperature of the battery of the above battery assembly, comprising the heating of the energy storage cells by the heat-transfer composition and/or the cooling of the energy storage cells by the heat-transfer composition, essentially without change of state of the heat-transfer composition.

The present invention makes it possible to meet the need expressed above. Specifically, it makes it possible to ensure optimum operation of the equipment, in particular a battery of an electric or hybrid vehicle (in particular the traction battery of the vehicle), so as to provide safe and efficient batteries having long lives, without increasing the costs.

This is accomplished through the use of a heat-transfer composition comprising from more than 0% to 40% by weight of a refrigerant chosen from halogenated hydrocarbons, perhalogenated compounds, fluorinated ketones, fluorinated ethers and the combinations thereof, and from 60% to less than 100% of a dielectric fluid, the energy storage cells of the battery being immersed in the heat-transfer composition in the liquid state, and the heat-transfer composition undergoing essentially no change of state.

The expression “undergoing essentially no change of state” is understood to mean that the composition does not undergo a change of state, other than on account of the possible variation in its vapor pressure as a function of the variation in the temperature. In particular, any change in state due to the variation in the vapor pressure preferably concerns less than 1% by weight of the composition, more preferably less than 0.5% by weight.

Preferably, the refrigerant has a boiling point below 50° C., more preferably below 30° C. and in particular below 25° C. or 20° C. (at 1 bar).

Specifically, the combination of a dielectric fluid with a refrigerant makes it possible to provide a composition that is not very viscous (in particular in comparison with a composition consisting of a dielectric fluid), which makes it possible for example to reduce the energy consumption of the system. Preferably, the heat transfer is thus more efficient than with a dielectric fluid alone.

Moreover, the presence of a compound with a low boiling point can help to slow down propagation in the event of thermal runaway of the battery.

Compared to the use of a refrigerant alone, the invention makes it possible to reduce the cost and the weight without significant degradation of the battery performance, lifespan or safety.

In addition, the vapor pressure of the composition is generally lower than that of the refrigerant alone, which makes it possible to reduce the constraints regarding the reinforcement of the unit.

Thus, the invention makes it possible generally to increase the efficiency, the lifespan and the safety of the batteries, in particular during fast charging, without increasing the costs.

Preferably, the composition has a volume resistivity of greater than or equal to 10⁶ Ω.cm at 25° C. Preferably, the composition exhibits a breakdown voltage of greater than or equal to 20 kV at 20° C. This ensures that the dielectric properties of the composition are compatible, from the viewpoint of safety, with use in direct contact with the cells.

Advantageously, the combination of refrigerant with the dielectric fluid also makes it possible to obtain compositions that are only slightly flammable or non-flammable.

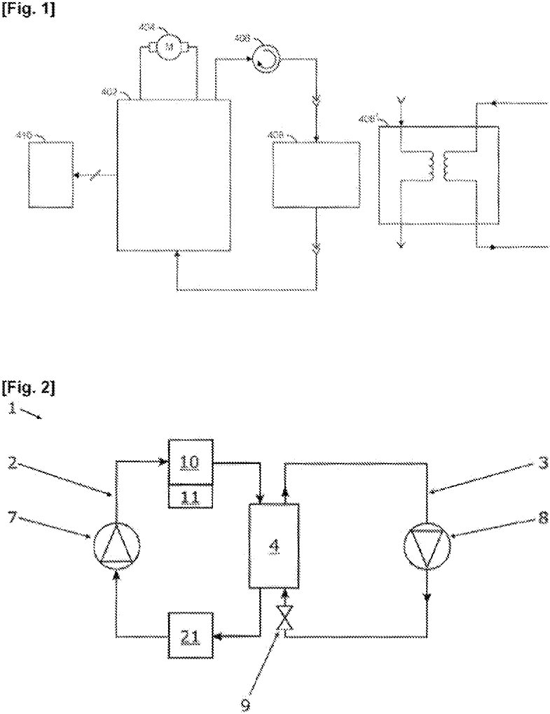

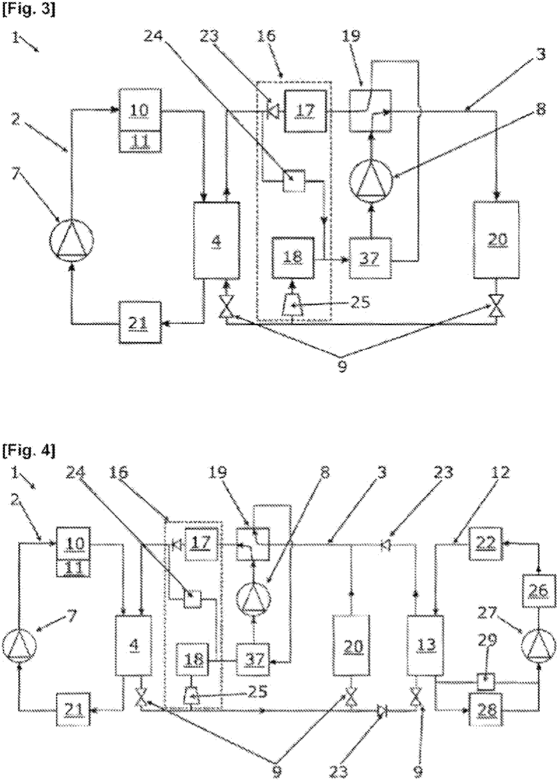

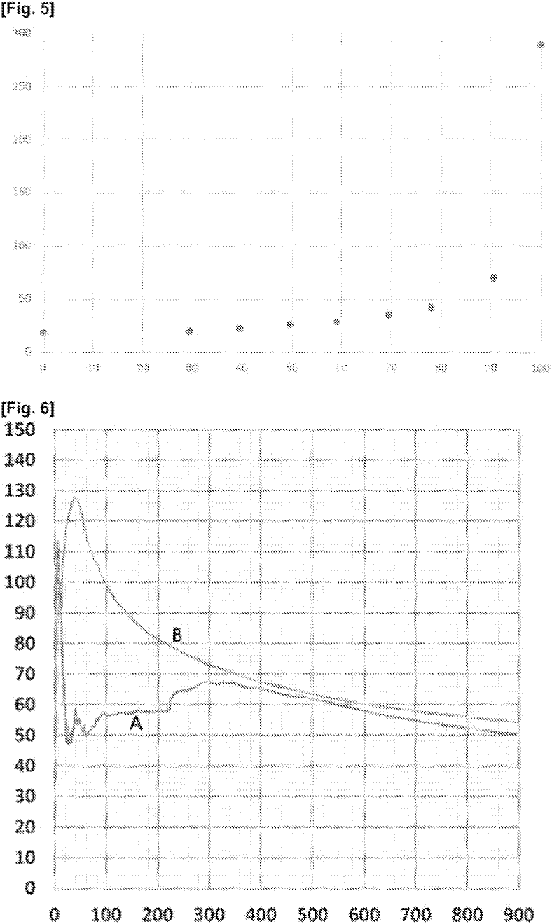

### BRIEF DESCRIPTION OF THE FIGURES

[FIG. 1] is a diagram which illustrates an embodiment of a battery assembly according to the invention.

[FIG. 2] is a diagram which illustrates an embodiment of a battery assembly according to the invention.

[FIG. 3] is a diagram which illustrates an embodiment of a battery assembly according to the invention.

[FIG. 4] is a diagram which illustrates an embodiment of a battery assembly according to the invention.

[FIG. 5] is a graph which illustrates the variation of the liquid saturation temperature of the heat-transfer composition at a pressure of 1 bar, as a function of the content of refrigerant (see the examples section below). The temperature is shown on the y-axis (°C) and the content of dielectric fluid is shown on the x-axis (wt%).

[FIG. 6] is a graph which shows the change in the temperature in an enclosure containing cells immersed in a fluid, one of the cells being subjected to thermal runaway. The temperature is represented on the y-axis (°C) and the time on the x-axis (s).

### DETAILED DESCRIPTION

The invention is now described in more detail and in a non-limiting way in the description which follows.

### Heat-Transfer Composition

The heat-transfer composition according to the invention comprises at least one refrigerant and at least one dielectric fluid.

The term “refrigerant” means a fluid that is capable of absorbing heat by evaporating at low temperature and low pressure and of discharging heat by condensing at high temperature and high pressure.

The refrigerant comprises a compound chosen from halogenated hydrocarbons, perhalogenated compounds, fluorinated ketones, fluorinated ethers and the combinations thereof.

The refrigerant can consist of one or more such compounds. Alternatively, it can also comprise one or more additional compounds chosen from hydrocarbons (alkanes or olefins, in particular propane, butane, isobutane, pentane, isopentane), CO₂ and oxygen-comprising hydrocarbons (in particular methoxymethane, ethoxyethane and methyl formate).

Preferably, the refrigerant consists of C₁, C₂, C₃, C₄ and/or C₅ compounds; more preferably C₁, C₂, C₃ and/or C₄ compounds.

Among the halogenated hydrocarbons, mention may be made of hydrofluorocarbons, hydrochlorofluorocarbons, hydrofluoroolefins, hydrochloroolefins and hydrochlorofluoroolefins.

By way of example, the refrigerant can be chosen from 1,1,1,4,4,4-hexafluorobut-2-ene (HFO-1336mzz, E or Z isomer), 1-chloro-3,3,3-trifluoropropene (HCFO-1233zd, E or Z isomer), 3,3,4,4,4-pentafluorobut-1-ene (HFO-1345fz), 2,4,4,4-tetrafluorobut-1-ene (HFO-1354mfy), 1,1,2-trifluoroethylene (HFO-1123), 2,3,3,3-tetrafluoropropene (HFO-1234yf), 1,3,3,3-tetrafluoropropene (HFO-1234ze, E or Z isomer, preferably E isomer), 1-chloro-2,3,3,3-tetrafluoropropene (HCFO-1224yd, E or Z isomer, preferably Z isomer), difluoromethane (HFC-32), 1,1,1,2-tetrafluoroethane (HFC-134a), 1,1,2,2-tetrafluoroethane (HFC-134), 1,1-difluoroethane (HFC-152a), pentafluoroethane (HFC-125), 1,1,1,3,3-pentafluoropropane (HFC-245fa), 1,1,1,2,3-pentafluoropropane (HFC-245eb), 1,1,1,2,3,3-hexafluoropropane (HFC-236ea), 1,1,1,3,3-pentafluorobutane (HFC-365mfc), fluoroethane (HFC-161), 1,1,1,2,3,3,3-heptafluoropropane (HFC-227ea), 1,1,1-trifluoropropane (HFC-263fb), 1,2-dichlorothisethylene (HCO-1130, E or Z isomer, preferably E isomer), and the combinations of these.

Preferred compounds are in particular HCFO-1233zd (preferably in E form), HFO-1336mzz (preferably in Z form) and HCFO-1224yd (preferably in Z form).

Perhalogenated compounds are composed of carbon atoms and of halogen atoms only. Mention may be made, for example, of perfluorinated compounds, such as dodecafluoropentane, tetradecafluorohexane, hexadecafluoroheptane and the combinations thereof.

mong the fluorinated ketones, mention may be made, for example, of fluorinated monoketones, perfluorinated monoketones, such as 1,1,1,2,2,4,5,5,5-nonafluoro-4-(trifluoromethyl)-3-pentanone, and the combinations thereof.

Among the fluorinated ethers, mention may be made, for example, of hydrofluoroethers such as methoxynonafluorobutane (HFE7100), ethoxynonafluorobutane (HFE-7200), 1-methoxyheptafluoropropane (HFE-7000), perfluoropolyethers and the combinations thereof.

The refrigerant can comprise several, for example two, or three, or four, or five, compounds as described above.

For example, the refrigerant can consist (or consist essentially) of:
a mixture of HFO-1234yf and HFC-134a;
a mixture of HFO-1336mzz(Z) and HCO-1130(E);
a mixture of HFO-1234ze(E) and HFC-227ea;
a mixture of HFO-1234yf, HFC-134a and HFC-152a;
a mixture of HFC-32, HFC-152a and HFO-1234ze(E);
a mixture of CO₂, HFC-134a and HFO-1234ze(E);
a mixture of HFC-32, HFO-1234ze(E) and butane;
a mixture of HFC-32, HFC-125 and HFO-1234ze(E);
a mixture of HFC-32, HFC-125, HFO-1234yf, HFC-134a and HFO-1234ze(E);
a mixture of HFC-32, HFC-125, HFO-1234yf and HFC-134a;
a mixture of HFC-134a and HFO-1234ze(E);
a mixture of HFC-32, HFC-125 and HFO-1234yf;
a mixture of HFC-32 and HFO-1234yf;
a mixture of CO₂, HFC-32 and HFO-1234yf;
a mixture of HFC-32, HFC-134a and HFO-1234ze(E);
a mixture of HFC-32, HFO-1234yf and HFC-152a;
a mixture of HFC-32, HFO-1234yf and HFO-1234ze(E);
a mixture of HFC-32, HFC-125, HFC-134a and HFO-1234ze(E);
a mixture of HFC-32, HFC-125, HFC-134a and HFO-1234ze(E);
a mixture of CO₂, HFC-32, HFC-125, HFO-1234yf and HFC-134a;
a mixture of HFC-32, HFC-125, HFO-1234ze(E) and HFC-227ea; and
a mixture of HFC-32, propane and HFO-1234yf.

Thus, the refrigerant can be a pure substance or a mixture. When it is a mixture, it is preferably an azeotropic or quasi-azeotropic mixture.

Preferred azeotropic compositions are the refrigerants:
R-513A (56% of HFO-1234yf and 44% of HFC-134a);
R-513B (58.5% of HFO-1234yf and 41.5% of HFC-134a);
R-514A (74.7% of HFO-1336mzz(Z) and 25.3% of HCO-1130(E));
R-515A (88% of HFO-1234ze(E) and 12% of HFC-227ea);
R-516A (77.5% of HFO-1234yf, 8.5% of HFC-134a and 14% of HFC-152a).

Alternatively, in certain embodiments, zeotropic compositions can be employed, and in particular the refrigerants:
R-444A (12% of HFC-32, 5% of HFC-152a and 83% of HFO-1234ze(E));
R-444B (41.5% of HFC-32, 10% of HFC-152a and 48.5% of HFO-1234ze(E));
R-445A (6% of CO₂, 9% of HFC-134a and 85% of HFO-1234ze(E));
R-446A (68% of HFC-32, 29% of HFO-1234ze(E) and 3% of butane);
R-447A (68% of HFC-32, 3.5% of HFC-125 and 28.5% of HFO-1234ze(E));
R-447B (68% of HFC-32, 8% of HFC-125 and 24% of HFO-1234ze(E));
R-448A (26% of HFC-32, 26% of HFC-125, 20% of HFO-1234yf, 21% of HFC-134a and 7% of HFO-1234ze(E));
R-449A (24.3% of HFC-32, 24.7% of HFC-125, 25.3% of HFO-1234yf and 25.7% of HFC-134a);
R-449B (25.2% of HFC-32, 24.3% of HFC-125, 23.2% of HFO-1234yf and 27.3% of HFC-134a);
R-449C (20% of HFC-32, 20% of HFC-125, 31% of HFO-1234yf and 29% of HFC-134a);
R-450A (42% of HFC-134a and 58% of HFO-1234ze(E));
R-451A (89.8% of HFO-1234yf and 10.2% of HFC-134a);
R-451B (88.8% de HFO-1234yfand 11.2% of HFC-134a);
R-452A (11% of HFC-32, 59% of HFC-125 and 30% of HFO-1234yf);
R-452B (67% of HFC-32, 7% of HFC-125 and 26% of HFO-1234yf);
R-452C (12.5% of HFC-32, 61% of HFC-125 and 26.5% of HFO-1234yf);
R-454A (35% of HFC-32 and 65% of HFO-1234yf);
R-454B (68.9% of HFC-32 and 31.1% of HFO-1234yf);
R-454C (21.5% of HFC-32 and 78.5% of HFO-1234yf);
R-455A (3% of CO₂, 21.5% of HFC-32 and 75.5% of HFO-1234yf);
R-456A (6% of HFC-32, 45% of HFC-134a and 49% of HFO-1234ze(E));
R-457A (18% of HFC-32, 70% of HFO-1234yf and 12% of HFC-152a);
R-459A (68% of HFC-32, 26% of HFO-1234yf and 6% of HFO-1234ze(E));
R-459B (21% of HFC-32, 69% of HFO-1234yf and 10% of HFO-1234ze(E));
R-460A (12% of HFC-32, 52% of HFC-125, 14% of HFC-134a and 22% of HFO-1234ze(E));
R-460B (28% of HFC-32, 25% of HFC-125, 20% of HFC-134a and 27% of HFO-1234ze(E));
R-460C (2.5% of HFC-32, 2.5% of HFC-125, 46% of HFC-134a and 49% of HFO-1234ze(E));
R-460A (12% of HFC-32, 52% of HFC-125, 14% of HFC-134a and 22% of HFO-1234ze(E));
R-463A (6% of CO₂, 36% of HFC-32, 30% of HFC-125, 14% of HFO-1234yf and 14% of HFC-134a);
R-464A (27% of HFC-32, 27% of HFC-125, 40% of HFO-1234ze(E) and 6% of HFC-227ea); and
R-465A (21% of HFC-32, 7.9% of propane and 71.1% of HFO-1234yf).

All the percentages shown are by weight.

In certain preferred embodiments, the refrigerant comprises HCFO-1233zd in E or Z form, and more preferably in E form.

Preferably, the heat-transfer composition according to the invention essentially comprises only one compound as refrigerant. In this case, it is preferable for this refrigerant to be HFO-1233zd in E or Z form, and more preferably in E form.

Impurities can be present at up to, for example, 1% by weight at the most.

The refrigerant can in particular comprise, by weight:
at least 99.5% of HCFO-1233zd(E), preferably at least 99.7%, more preferably at least 99.8%;
a content of HFC-245fa of less than or equal to 500 ppm, preferably from 1 to 500 ppm, more preferably from 2 to 300 ppm;
a content of HFO-1234ze (E or Z) of less than or equal to 100 ppm, preferably from 1 to 100 ppm, more preferably from 2 to 50 ppm;
a content of HCFO-1233zd (Z) of less than or equal to 100 ppm, preferably from 1 to 100 ppm, more preferably from 2 to 50 ppm.

Other preferred compositions are:
a mixture consisting (or consisting essentially) of HCFO-1233zd(E) and of HFC-245eb, preferably a quasi-azeotropic or azeotropic composition;
a mixture consisting (or consisting essentially) of HFO-1366mzz(Z) and of HCO-1130(E), preferably a quasi-azeotropic or azeotropic composition, and more preferably the refrigerant R-514A.

The refrigerant according to the invention may notably have a liquid viscosity of from 0.1 to 2 cP at 20° C., preferably from 0.2 to 0.9 cP at 20° C. The viscosity may be measured according to the method indicated in example 2 below.

The refrigerant according to the invention can in particular have a liquid saturation temperature of from 0° C. to 50° C., preferably from 10° C. to 30° C., in particular from 15° C. to 25° C., at 1 bar.

The refrigerant according to the invention can in particular have a density of from 1 to 1.7, preferably from 1 to 1.5, preferably of 1 to 1.4, at 20° C.

For the purposes of the present invention, the expression “dielectric fluid” is understood to mean a fluid, generally an oil, which does not conduct (or conducts very little) electricity but allows electrostatic forces to be exerted.

The term “oil” means a fatty substance which is in the liquid state at ambient temperature and which is immiscible with water. Oils are fatty liquids of vegetable, mineral or synthetic origin. It can be chosen from oils belonging to groups I to V as defined in the API classification (or their equivalents according to the ATIEL classification).

Insulating (dielectric) oils have characteristics of heat-exchange fluids and thus participate in the transfer of heat just like the refrigerant.

The oil included in the heat-transfer composition can be chosen in particular from mineral dielectric oils, synthetic dielectric oils, which are optionally biobased, and vegetable dielectric oils, and also the combinations thereof.

Preferably, the dielectric fluid comprises at least one mineral dielectric oil. Nonlimiting examples of such mineral dielectric oils comprise paraffinic oils and naphthenic oils, such as the dielectric oils of the Nytro family, sold by Nynas (in particular Nytro Taurus, Nytro Libra, Nytro 4000X and Nytro 10XN), and Dalia, sold by Shell.

The mineral dielectric oils can preferably be paraffinic oils (that is to say, saturated linear or branched hydrocarbons), such as the Nytro Taurus oil sold by Nynas and the Dalia oil sold by Shell, or naphthenic oils (that is to say, cyclic paraffins), such as the Nytro Libra and Nytro 10XN oils sold by Nynas, aromatic compounds (that is is to say, unsaturated cyclic hydrocarbons containing one or more rings characterized by double bonds alternating with single bonds) and non-hydrocarbon compounds.

Preferably, the dielectric fluid is an optionally biobased synthetic dielectric oil. Preferably, they can be aromatic hydrocarbons, aliphatic hydrocarbons, silicone oils, esters and polyesters, in particular polyol esters, and also mixtures of two or more thereof in any proportions.

Among the aromatic hydrocarbons, mention may be made, in a nonlimiting manner, of alkylbenzenes, alkyldiphenylethanes (for example phenylxyxlyethane (PXE), phenylethylphenylethane (PEPE), monoisopropylbiphenyl (MIPB), 1,1-diphenylethane (1,1-DPE)), alkylnaphthalenes (for example diisopropylnaphthalene (DIPN)), methylpolyarylmethanes (for example benzyltoluene (BT) and dibenzyltolulene DBT), and mixtures thereof. In said aromatic hydrocarbons, it should be understood that at least one ring is aromatic and that optionally one or more other rings present may be partially or totally unsaturated. Mention may be made in particular of the dielectric fluids sold by Soltex Inc., by Arkema under the name Jarylec®, and SAS 60E from JX Nippon Chemical Texas Inc.

Among the aliphatic hydrocarbons, mention may be made, in a nonlimiting manner, of alkanes, poly(α-)olefins (PAO), for example polyisobutenes (PIB) or olefins of vinylidene type, such as those sold, for example, by Soltex Inc.

The alkanes can in particular comprise at least 8 carbon atoms, for example between 8 and 22 carbon atoms, preferably between 15 and 22 carbon atoms.

The PAOs can be chosen from group IV and are, for example, obtained from monomers comprising from 4 to 32 carbon atoms, for example from octene or decene. The weight-average molecular weight of the PAO can vary quite widely. Preferably, the weight-average molecular weight of the PAO is less than 600 Da. The weight-average molecular weight of the PAO can also range from 100 to 600 Da, from 150 to 600 Da, or else from 200 to 600 Da. For example, PAOs exhibiting a kinematic viscosity, measured at 100° C. according to the standard ASTM D445, ranging from 1.5 to 8 mm²/s are sold commercially by Ineos under the brand names Durasyn® 162, Durasyn® 164, Durasyn® 166 and Durasyn® 168.

Among the silicone oils, mention may be made, in a nonlimiting manner, of linear silicone oils of the polydimethylsiloxane type, for instance those sold by Wacker under the name Wacker® AK.

Among the synthetic esters, mention may be made, in a nonlimiting manner, of esters of the phthalic type such as dioctyl phthalate (DOP) or diisononyl phthalate (DINP) (sold, for example, by BASF).

Mention may also be made, in a nonlimiting manner, of esters resulting from the reaction between a polyalcohol and an organic acid, in particular an acid chosen from saturated or unsaturated C₄ to C₂₂ organic acids. As nonlimiting examples of such organic acids, mention may be made of undecanoic acid, heptanoic acid, octanoic acid, palmitic acid and mixtures thereof. Among the polyols that may be used for the synthesis of the abovementioned esters, nonlimiting examples that may be mentioned include pentaerythritol for the synthesis of the oil Mivolt DF7 Midel 7131, and Mivolt DFK from M&I Materials.

The esters can, for example, be diesters of formula R^{a}—C(O)—O—([C(R)₂]ₙ—O)ₛ—C(O)—R^{b}, in which each R independently represents a hydrogen atom or a linear or branched C₁-C₅ alkyl group, in particular a methyl, ethyl or propyl group, notably a methyl group; s is 1, 2, 3, 4, 5 or 6; n is 1, 2 or 3; it being understood that, when s is other than 1, the n values can be identical or different; and R^{a} and R^{b}, which are identical or different, represent, independently of each other, saturated or unsaturated and linear or branched hydrocarbon groups having a linear sequence of 6 to 18 carbon atoms. Preferably, when s and n are identical and are equal to 2, at least one of the R groups represents a linear or branched C₁-C₅ alkyl group; and when s is 1 and n is 3, at least one of the R groups bonded to the carbon in the β position of the oxygen atoms of the ester functions represents a hydrogen atom.

The synthetic esters resulting from the reaction between a polyalcohol and an organic acid are, for example, Midel 7131 from M&I Materials or else the esters of the Nycodiel range from Nyco.

Among the natural esters and vegetable oils, nonlimiting examples that may be mentioned include products from oily seeds or from other sources of natural origin. Nonlimiting examples that may be mentioned include FR3™ or Envirotemp™ sold by Cargill or else Midel eN 1215 sold by M&I Materials.

Use may also be made of a polyalkylene glycol (PAG), in particular obtained by polymerization or copolymerization of alkylene oxides comprising from 2 to 8 carbon atoms, in particular from 2 to 4 carbon atoms.

The heat-transfer composition according to the invention may comprise one oil or more, for example two, or three, or four or five oils.

A preferred dielectric fluid is a polyol ester manufactured from pentaerythritol.

Another preferred dielectric fluid is a poly(α-)olefin (PAO) comprising predominantly (that is to say, to more than 50% by weight) isoparaffins comprising from 4 to 32 carbon atoms. This fluid belongs to group IV of the API classification.

Preferably, the heat-transfer composition according to the invention comprises only one dielectric fluid.

The dielectric fluid may notably have a viscosity of from 1 to 60 cP at 20° C. according to the standard ISO3104.

The dielectric fluid may notably have a boiling point of greater than 30° C., as measured by ebulliometry.

The dielectric fluid may be present in the composition at a content of from 60% to less than 100%, preferably from 85% to 99.5% by weight relative to the total weight of the heat-transfer composition.

For example, this content may be from 60% to 65%; or from 65% to 70%; or from 70% to 75%; or from 75% to 80%; or from 80% to 85%; or from 85% to 86%; or from 86% to 87%; or from 87% to 88%; or from 88% to 89%; or from 89% to 90%; or from 90% to 91%; or from 91% to 92%; or from 92% to 93%; or from 93% to 94%; or from 94% to 95%; or from 95% to 96%; or from 96% to 97%; or from 97% to 98%; or from 98% to 99%; or from 99% to less than 100%, by weight relative to the total weight of the heat-transfer composition.

The refrigerant may be present in the composition in a content of from more than 0 to 40%, preferably from 0.5% to 15%, by weight relative to the total weight of the heat-transfer composition.

For example, this content may be from more than 0% to 1%, or from 1% to 2%; or from 2% to 3%; or from 3% to 4%; or from 4% to 5%; or from 5% to 6%; or from 6% to 7%; or from 7% to 8%; or from 8% to 9%; or from 9% to 10%; or from 10% to 11%; or from 11% to 12%; or from 12% to 13%; or from 13% to 14%; or from 14% to 15%; or from 15% to 20%; or from 20% to 25%; or from 25% to 30%; or from 30% to 35%; or from 35% to 40%, by weight relative to the total weight of the heat-transfer composition.

In certain embodiments, the heat-transfer composition according to the invention comprises a polyol ester manufactured from pentaerythritol and at least one fluorinated or fluorochlorinated hydrocarbon, for instance, in a nonlimiting manner, hydrofluoropropane, hydrofluoropropene, hydrochlorofluoropropane, hydrochlorofluoropropene, and also mixtures thereof in any proportions.

In other embodiments, the heat-transfer composition according to the invention comprises a poly(α-)olefin (PAO) and at least one fluorinated or fluorochlorinated hydrocarbon, for instance, in a nonlimiting manner, a hydrofluoropropane, a hydrofluoropropene, a hydrochlorofluoropropane, a hydrochlorofluoropropene and also mixtures thereof in any proportions.

Preferably, the heat-transfer composition according to the invention comprises HCFO-1233zd (preferably in E form) and a polyol ester manufactured from pentaerythritol. Even more preferentially, the heat-transfer composition according to the invention consists essentially, or even consists, of HCFO-1233zd (preferably in E form) and a polyol ester manufactured from pentaerythritol.

Preferably, the heat-transfer composition according to the invention comprises HCFO-1233zd (preferably in E form) and a poly(α-)olefin (PAO). Even more preferentially, the heat-transfer composition according to the invention consists essentially, or even consists, of HCFO-1233zd (preferably in E form) and a poly(α-)olefin (PAO). It can also consist essentially, or consist, of HCFO-1233zd in Z form, HFC-245eb and a PAO. It can also consist essentially, or consist, of HFO-1336mzz in Z form and a PAO. It can also consist essentially, or consist, of HFO-1336mzz in Z form, HCO-1130 in E form and a PAO.

The composition that may be used in the context of the present invention may further comprise one or more additives and/or fillers, chosen, for example, in a nonlimiting manner, from antioxidants, passivators, pour point depressants, decomposition inhibitors, fragrances and flavorings, colorants, preservatives, and mixtures thereof. The presence of a decomposition inhibitor is particularly preferred.

Among the antioxidants that may advantageously be used in the composition, nonlimiting examples that may be mentioned include phenolic antioxidants, for instance dibutylhydroxytoluene, butylhydroxyanisole, tocopherols, and also acetates of these phenolic antioxidants; antioxidants of the amine type, for instance phenyl-a-naphthylamine, of the diamine type, for example N,N′-bis(2-naphthyl)-para-phenylenediamine, ascorbic acid and its salts, esters of ascorbic acid, alone or as mixtures of two or more thereof or with other components, for instance green tea extracts, coffee extracts.

A particularly suitable antioxidant is the product commercially available from Brenntag under the trade name Ionol®.

The passivators that may be used in the context of the present invention are advantageously chosen from triazole derivatives, benzimidazoles, imidazoles, thiazole and benzothiazole. Nonlimiting examples that may be mentioned include dioctylaminomethyl-2,3-benzotriazole and 2-dodecyldithioimidazole.

Among the pour point depressants that may be present, nonlimiting examples that may be mentioned include fatty acid esters of sucrose, and acrylic polymers such as poly(alkyl methacrylate) or poly(alkyl acrylate).

The preferred acrylic polymers are those with a molecular weight of between 50,000 g.mol⁻¹ and 500,000 g.mol⁻¹. Examples of these acrylic polymers include polymers which can contain linear alkyl groups comprising from 1 to 20 carbon atoms.

Mention may be made, among these and still as nonlimiting examples, of poly(methyl acrylate), poly(methyl methacrylate), poly(heptyl acrylate), poly(heptyl methacrylate), poly(nonyl acrylate), poly(nonyl methacrylate), poly(undecyl acrylate), poly(undecyl methacrylate), poly(tridecyl acrylate), poly(tridecyl methacrylate), poly(pentadecyl acrylate), poly(pentadecyl methacrylate), poly(heptadecyl acrylate) and poly(heptadecyl methacrylate).

An example of such a pour point depressant is commercially available from the company Sanyo Chemical Industries Ltd under the trade name Aclube.

According to a most particularly preferred aspect, a decomposition inhibitor is present as an additive. The decomposition inhibitor may be chosen in particular from carbodiimide derivatives such as diphenyl carbodiimide, ditolyl carbodiimide, bis(isopropylphenyl)carbodiimide, bis(butylphenyl)carbodiimide; but also from phenylglycidyl ethers, or esters, alkylglycidyl ethers, or esters, 3,4-epoxycyclohexylmethyl(3,4-epoxycyclohexane) carboxylate, the compounds of the anthraquinone family, for instance β-methylanthraquinone sold under the name “BMAQ”, epoxide derivatives such as vinylcyclohexene diepoxides, 3,4-epoxy-6-methylcyclohexylmethyl (3,4-epoxy-6-methylhexane) carboxylate, phenol novolak type epoxy resins, diglycidyl epoxy ether of bisphenol A, such as DGEBA or CEL 2021P, which are notably available from the company Whyte Chemicals.

The total amount of additives preferably does not exceed 5% by weight, in particular 4%, more particularly 3% and most particularly 2% by weight or even 1% by weight of the heat-transfer composition.

The composition according to the invention may be prepared by any means well known to a person skilled in the art, for example by simple mixing of the various components of the composition according to the invention.

In certain embodiments, the heat-transfer composition contains impurities. When present, they may represent less than 1%, preferably less than 0.5%, preferably less than 0.1%, preferably less than 0.05% and preferably less than 0.01% (by weight) relative to the heat-transfer composition.

The heat-transfer composition according to the invention preferably has a volume resistivity of greater than or equal to 10⁶ Ω.cm at 25° C., and preferably greater than or equal to 10⁷ Ω.cm or 10⁸ Ω.cm. The resistivity of a material represents its capacity to oppose the flow of electric current. In other words, the volume resistivity is an indication of the dielectric properties of the composition. Volume resistivity is measured according to the standard IEC 60247.

For example, this volume resistivity may be from 10⁶ to 5×10⁶ Ω.cm; or from 5×10⁸ to 10⁷ Ω.cm; or from 10⁷ to 5×10⁷ Ω.cm; or from 5×10⁷ to 10⁸ Ω.cm; or from 10⁸ to 5×10⁸ Ω.cm; or from 5×10⁸ to 10⁹ Ω.cm; or more than 10⁹ Ω.cm.

Furthermore, the heat-transfer composition according to the invention preferably has a breakdown voltage at 20° C. greater than or equal to 20 kV, preferably greater than or equal to 20 kV, preferably greater than or equal to 30 kV, preferably greater than or equal to 50 kV, and more preferably greater than or equal to 100 kV. The term “breakdown voltage” is understood to mean the minimum electrical voltage which renders a portion of an insulator conductive. Thus, this parameter is also an indication of the dielectric properties of the composition. The breakdown voltage is measured according to the standard IEC 60156.

For example, the breakdown voltage at 20° C. of the composition according to the invention may be from 25 to 30 kV; or from 30 to 40 kV; or from 40 to 50 kV; or from 50 to 60 kV; or from 60 to 70 kV; or from 70 to 80 kV; or from 80 to 90 kV; or from 90 to 100 kV; or from 100 to 110 kV; or from 110 to 120 kV; or from 120 to 130 kV; or from 130 to 140 kV; or from 140 to 150 kV.

The heat-transfer composition according to the invention may also have a liquid saturation temperature of from 20 to 80° C., and preferably from 30 to 70° C. at a pressure of 1 bar. For example, this temperature may be from 20° C. to 25° C.; or from 25° C. to 30° C.; or from 30° C. to 35° C.; or from 35° C. to 40° C.; or from 40° C. to 45° C.; or from 45° C. to 50° C.; or from 50° C. to 55° C.; or from 55° C. to 60° C.; or from 60° C. to 65° C.; or from 65° C. to 70° C.; or from 70° C. to 75° C.; or from 75° C. to 80° C.

The heat-transfer composition according to the invention may notably have a viscosity of from 0.1 to 20 cP at 20° C. according to the standard ISO 3104.

The heat-transfer composition according to the invention is preferably only slightly flammable (that is to say, having a high flash point, for example greater than 150° C., or than 200° C., or than 250° C., or than 300° C., according to the standards ISO 3679 and ISO 3680) or more preferably nonflammable.

### Use of the Heat-Transfer Composition

With reference to FIG. 1, the battery 402 can power at least one motor 404, in particular a vehicle motor. The vehicle is preferably an automobile, or possibly a construction machine, scooter, motorcycle, truck, ship, aircraft, and the like.

The battery can comprise a set of energy storage cells (or accumulators), which can be grouped together in a single module or several modules. Each module can contain a plurality of cells arranged in a sealed enclosure. Each module enclosure can be configured in order to hold the cells in a fixed fashion.

The battery can comprise identical or different modules. The modules can be assembled together mechanically and/or connected electrically, to form the battery. The modules can be electrically connected in series, or in parallel.

Each enclosure can, for example, comprise an upper portion and a lower portion connected together, for example by welding, adhesive bonding or screwing.

The cells can, for example, be of cylindrical shape. Each module can comprise from 2 to 200 cells, preferably from 4 to 100 cells, more preferably from 6 to 50 cells. The cells can, for example, be arranged in N rows of M cells in each module. N may be, for example, from 1 to 10, for example may be 2. M may be, for example, from 1 to 60, and for example may be a multiple of 3 (namely 3, 6, 12, 18, 30, and the like). In certain embodiments, the cells can be ordered according to a three-dimensional arrangement in each module, with a stack of P layers of NxM cells. The number of layers P can then have a value, for example, from 2 to 5. Alternatively, a single layer is present.

The cells can, for example, be rechargeable nickel-cadmium (NiCd), nickel metal hydride (Ni—M—H) or lithium-ion (Li-ion) cells.

Each enclosure can, for example, be made of plastic, in particular of polystyrene, polyvinyl chloride, polycarbonate, polyethylene, polypropylene, acrylic polymer and in particular polymethyl methacrylate, phenolic resin, and the like. Alternatively, it can be made of metallic material, for example of aluminum.

The heat-transfer composition is used to regulate the temperature of the battery. This regulation is carried out by placing the heat-transfer composition in direct contact with energy storage cells of the battery, the heat-transfer composition being entirely in the liquid state. In other words, the energy storage cells are immersed in the heat transfer composition in the liquid state, and the heat-transfer composition undergoes essentially no change of state under the normal operating conditions of the battery.

Thus, the heat transfer composition is used for single-phase cooling known as SPLC (“single phase liquid cooling”) - it being understood that, in certain embodiments, it can also or alternatively be used for single-phase heating.

The term “immersed” is understood to mean that the cells are in contact with the heat-transfer composition. More particularly, the exterior surfaces of the cells are in contact with the heat-transfer composition. Preferably, they are in contact with the heat-transfer composition essentially in liquid form.

The cells can thus be arranged in a bath of heat-transfer composition. The heat-transfer composition can occupy the entire internal space of the module, between the cells and the wall of the enclosure, or preferably a gaseous headspace can be provided. Preferably, the entire surface of the cells in the enclosure is in contact with the composition in liquid form.

Alternatively, the surface of the cells can be covered with a liquid film obtained by suitable means (sprinkling, projection, jet, and the like) and/or by specific treatment of the surface of the cells.

For example, the heat-transfer composition can be sprayed over the cells by monodirectional or multidirectional nozzles. They can, for example, be arranged between the cells so as to project the heat-transfer composition onto side faces of the cells. Alternatively, they are placed above the cells to project the heat-transfer composition onto upper faces of the cells. The composition can be projected in the form of a jet, or trickled, or be in the form of a mist. The composition can be recovered in a tank and recirculated by a pump. A heat exchanger and/or a heating means (for example a resistance heating means) can be arranged in the reservoir, or upstream or downstream of the pump, to make it possible to supply or remove heat to or from the composition. In this variant, the liquid composition may be brought into contact with the surface of the cells only when there is a need to regulate the temperature of the battery. The rest of the time, and in particular when the battery is not in operation, the surface of the cells may not be in contact with the heat-transfer composition.

Optionally, the surface of the cells can be coated with a hydrophilic film in order to make it possible to distribute a liquid layer of heat-transfer composition over the surface of the cells. For example, a nanostructured SiO₂ film can be employed. Alternatively, a filamentary or fibrous structure (comprising one or more rovings, or a woven or nonwoven textile), or else an agglomerated metal powder, can be arranged at the surface of the cells, in order to make it possible to distribute a liquid layer of heat-transfer composition over the surface of the cells by capillary action.

Immersion allows the thermal properties of the heat-transfer composition to be used to best advantage. In particular, direct contact cooling of the battery cells with the heat-transfer composition is useful in the event of fast charging of the battery, which involves the rapid heating up of the battery. It enables the temperature to be kept uniform in its optimal operating range.

The heat transfer composition is contained in a device, which is suitable for allowing heat exchange between the composition and the battery cells, and preferably also between the composition and a secondary source.

This device, with the battery itself, constitutes a battery assembly according to the invention.

The secondary source can be ambient air or an additional heat-transfer composition. When it is ambient air, one or more fans can be used to increase the heat exchange therewith.

The heat-transfer composition can be static or circulating.

If it is static, the device comprises the enclosure(s) containing the cells of the battery, as well as the heat-transfer composition in contact with these cells. The heat-transfer composition exchanges heat with the surroundings or an additional heat-transfer composition via the enclosure itself. The internal wall and/or the external wall of the enclosure can thus comprise heat-dissipation elements, such as fins or another structure in relief, in order to facilitate heat exchanges with the surroundings or the additional heat-transfer composition. Alternatively, the heat-transfer composition may exchange heat with the additional heat-transfer composition, via a heat exchanger located in the enclosure or directly via the wall of the enclosure, or via plates or channels on the wall of the enclosure.

When the heat-transfer composition is circulating, the device comprises a main heat-transfer circuit, as illustrated in FIG. 1.

The flow rate of the heat-transfer composition in the main circuit can be from 0 to 100 I/min, preferably from 5 to 50 I/min.

The enclosure of each module can be provided with at least one fluid inlet and at least one fluid outlet, to enable the heat-transfer composition to pass through the enclosure, the cells being immersed, preferably entirely, in the heat-transfer composition.

To avoid thermal shocks, it may be preferred for the temperature of the heat-transfer composition, at the inlet of the enclosure, to be greater than or equal to 10° C., for example between approximately 20° C. and approximately 30° C.

The modules can be fluidically connected in series, or in parallel, with respect to the circulation of the heat-transfer composition.

With reference again to FIG. 1, the main heat-transfer circuit can be configured to transport the heat-transfer composition originating from at least one heat exchanger 408, 408′ to the battery 402, and again from the battery 402 to the at least one heat exchanger 408, 408′. The module enclosure(s) are incorporated in this main circuit. The main circuit can comprise one or more pipes for supplying the heat-transfer composition to the battery and for collecting it; and optionally for transporting it between modules of the battery. Alternatively, the enclosures of the modules can be in direct contact so as to enable the assembling of the respective fluid inlets and outlets of the modules. In this case, seals can be provided between the assembled inlets and outlets.

Distributors and collectors can be attached to or incorporated in the enclosures, when several fluid inlets and/or several fluid outlets are provided in each enclosure. In certain embodiments, portions of distributors and collectors can be formed in the enclosures themselves, so as to enable the collection and distribution of the heat-transfer composition from one module to the other when the respective enclosures are assembled.

When it is circulating, the transportation of the heat-transfer composition in the main circuit can be provided by one or more pumps 406. The main circuit does not comprise a compressor: in other words, the main circuit is not a vapor compression circuit.

The heat exchanger 408 can in particular be a radiator ensuring heat exchange with the ambient air.

Alternatively, the heat exchanger 408′ couples the main circuit with a secondary circuit in which an additional heat-transfer composition circulates, which composition itself exchanges heat with another source, for example with the ambient air.

The additional heat-transfer composition can be identical to or different from the heat-transfer composition. For example, it can be a refrigerant as described above, not mixed with a dielectric fluid. For example, the composition can comprise HFO-1234yf, combined, if appropriate, with one or more lubricants and other additives. Alternatively, it can be a mixture of water and glycol, for example.

This secondary circuit can be a refrigeration circuit, comprising a compressor, an expansion valve, an evaporator and a condenser; or it can be a simple heat-exchange circuit devoid of compressor.

An expansion valve (for example an electronic expansion valve) can be provided upstream of the heat exchanger 408′ in this secondary circuit.

A pump can be provided in this secondary circuit in order to circulate the additional heat-transfer composition.

The additional heat-transfer composition can optionally change state, completely or partially, on passing through the heat exchanger 408′. Thus, if the heat-transfer composition is cooled in the heat exchanger 408′, the additional heat-transfer composition is correspondingly heated and can completely or partially evaporate (for example from a completely liquid state to a two-phase liquid-vapor state). Conversely, if the heat-transfer composition is heated in the heat exchanger 408′, the additional heat-transfer composition is correspondingly cooled and can completely or partially condense (for example from a two-phase liquid-vapor state to a completely liquid state).

Optionally, the secondary circuit can be reversible (that is to say that it can cool or heat the heat-transfer composition which is in contact with the battery, depending on the operating mode).

The heat exchanger 408′ enabling heat exchange with the additional heat-transfer composition can, for example, be cocurrent or, preferably, countercurrent.

The term “countercurrent heat exchanger” means a heat exchanger in which heat is exchanged between a first fluid and a second fluid, the first fluid at the inlet of the exchanger exchanging heat with the second fluid at the outlet of the exchanger, and the first fluid at the outlet of the exchanger exchanging heat with the second fluid at the inlet of the exchanger.

For example, countercurrent heat exchangers comprise devices in which the flow of the first fluid and the flow of the second fluid are in opposite or virtually opposite directions. Exchangers operating in crosscurrent mode with a countercurrent tendency are also included among countercurrent heat exchangers.

The heat exchangers can in particular be U-tube exchangers, exchangers with a horizontal or vertical tube bundle, spiral exchangers, plate exchangers or fin exchangers.

The additional heat transfer composition can itself exchange heat with the surroundings, by means of an additional heat exchanger. It can optionally also be used to heat or cool the air of the passenger compartment of the vehicle. Thus, the heat dissipated by the battery can be absorbed by the air conditioning circuit of the vehicle.

To this end, the secondary circuit may include various branches with separate heat exchangers, the additional heat transfer composition optionally flowing in these branches, depending on the operating mode. Optionally, alternatively or additionally, the secondary circuit may include means for changing the direction of flow of the additional heat-transfer composition, for example comprising one or more three-way or four-way valves.

The main circuit in a circulating system may comprise a tank for the storage of the excess heat-transfer composition in liquid form.

The secondary circuit may comprise a tank for the storage of the excess heat-transfer composition in liquid form.

In the main circuit in a circulating system, protection can be provided, for example upstream of the pump, in order to ensure that only liquid is pumped to the battery. This is because, depending on the external conditions (for example when the vehicle is hot on start-up due to the weather conditions), the heat-transfer composition may be two-phase upstream of the pump, in particular at the outlet of the tank. The protection can comprise a bypass system, in particular between the tank and the pump, with a valve, a pressure sensor and a temperature sensor. A filter and a dryer can be provided in order to capture impurities and moisture respectively.

It is possible to further provide a third circuit containing another additional heat-transfer composition, thermally connected to the secondary circuit, by a heat exchanger. This third circuit can in particular be dedicated to the recovery of the heat dissipated by the motor and/or the electrical components of the vehicle.

It is possible to provide two or more than two main circuits operated in parallel and controlled independently, in order to regulate the temperature of different modules of the battery or to control different batteries when there are several of them.

A battery management system 410 can be combined with the battery 402, in order to measure the electrical parameters (in particular the voltage) but also the temperature of each module (by means of temperature sensors) and to control the modules and also the main circuit (and optionally the secondary circuit), and in particular their pumps, in order to ensure that the electrical parameters in question and the temperature are within desired ranges.

Specific examples of thermal regulation systems comprising a main circuit and a secondary circuit are now described in more detail.

With reference to FIG. 2, an example of a battery assembly according to the invention (which can be used in particular in a vehicle) comprises a thermal regulation system 1 which comprises a main circuit 2 containing the heat-transfer composition described above and a secondary circuit 3 containing an additional heat-transfer composition, the two circuits being thermally connected by at least one heat exchanger 4. When it is circulating, the heat-transfer composition in the main circuit 2 can be set in motion by a pump 7. The additional heat-transfer composition in the secondary circuit 3 is set in motion by a pump 8. The secondary circuit 3 comprises an expansion valve 9 making it possible to ensure the evaporation of the additional heat-transfer composition in the heat exchanger 4, in order to cool the heat-transfer composition of the main circuit 2.

At least one battery module 10 (as described above) is fluidically incorporated in the main circuit 2. A heating element 11 can be combined with the battery module 10 or incorporated therein.

In a circulating system, a tank 21 can optionally be provided in the main circuit 2 in order to receive an excess of heat-transfer composition in liquid form.

In battery cooling mode, the pump 7 withdraws the heat-transfer composition from the tank 21 and sends it to the battery module 10. The heat-transfer composition remains in the liquid state on passing through the battery module 10.

The heat-transfer composition subsequently passes through the heat exchanger 4. The additional heat-transfer composition is expanded in the expansion valve 9 and then completely or partially vaporizes in the heat exchanger 4. The heat-transfer composition transfers heat to the additional heat-transfer composition. The heat-transfer composition subsequently returns to the tank 21.

The secondary circuit 3 can be the automotive air conditioning circuit of the vehicle (the compressor not being illustrated in the figure).

With reference to FIGS. 3 and 4, an example of a battery assembly according to the invention (which can be used in particular in a vehicle) comprises a thermal regulation system 1 which comprises a main circuit 2 as described above and a secondary circuit 3 capable of operating as a reversible heat pump. Thus, the battery module 10 can be cooled and heated by the heat-transfer composition. The secondary circuit has two operating modes: a cooling mode and a heating mode. The cooling mode is illustrated in FIG. 3 and the heating mode is illustrated in FIG. 4.

The secondary circuit 3 comprises an HVAC (heating, ventilation and air conditioning) module 16 providing the thermal regulation of the air of the passenger compartment. It comprises a condenser 17 and an evaporator 18. The condenser 17 is used to heat the air of the passenger compartment and the evaporator 18 is used to cool it.

The secondary circuit 3 additionally comprises a control valve 19, a shut-off valve 24, a tank 37 and an external heat exchanger 20. An expansion valve 9 is arranged downstream of the external heat exchanger 20 and a calibrated orifice 25 with shut-off function is arranged upstream of the evaporator 18. The expansion valve 9, the shut-off valve 24 and the calibrated orifice 25 can be electrically controlled. The control valve 19 can be a reversible valve and/or a four-way valve capable of changing the direction of circulation of the additional heat-transfer composition.

In cooling mode, the control valve 19 is in a first position such that the external heat exchanger 20 is used as a condenser while the heat exchanger 4 and the evaporator 18 are used as evaporators. The shut-off valve 24 and the calibrated orifice 25 are open in this mode. The additional heat-transfer composition in the tank 37 is in a two-phase state and the pump 8 sends it to the external heat exchanger 20. The additional heat-transfer composition condenses in the latter and is sent to the heat exchanger 4 and the evaporator 18. In both cases, it is at least partially vaporized and returned to the tank 37.

In heating mode, the control valve 19 is in a second position such that the external heat exchanger 20 is used as an evaporator while the heat exchanger 4 and the condenser 17 are used as condensers. The shut-off valve 24 and the calibrated orifice 25 are closed in this mode. The additional heat-transfer composition in the tank 37 is in a two-phase state and the pump 8 sends it to the condenser 17 where it is partially condensed. It is then sent to the heat exchanger 4, where it continues to condense. It then passes through the external heat exchanger 20 having an evaporator function.

Optionally, a third circuit 12 can be provided and play a part in heating mode. The third circuit 12 can make it possible to recover heat dissipated by a motor 26 and/or electrical components 22 of the vehicle. It can comprise a pump and a radiator 28. A bypass fitted with a shut-off valve 29 can make it possible for the radiator 28 to be bypassed. The third circuit 12 is thermally connected to the secondary circuit 3 by a second heat exchanger 13. The third circuit can, for example, comprise a fluid of water and glycol mixture type. In heating mode, the additional heat-transfer composition, at the outlet of the heat exchanger 4, is distributed in the external heat exchanger 20 and in the second heat exchanger 13, both of which have an evaporator function. It thus absorbs the heat dissipated by the fluid of the third circuit 12.

The secondary circuit 3 can comprise two non-return valves 23 on the branch of the circuit comprising the second heat exchanger 13 (in parallel with the branch comprising the external heat exchanger 20), and also an expansion valve 9 upstream of the second heat exchanger 13.

### Temperature Control

The invention relates to the use of a heat-transfer composition according to the invention for regulating the temperature of the battery. Preferably, the composition is used for cooling the battery. It may also be used for heating the battery. Heating and cooling can be alternated according to requirements (outside temperature, temperature of the battery, operating mode of the battery). Heating the battery is useful in particular on starting the vehicle, when the outside temperature is cold (for example less than 10° C., or than 0° C., or than -10° C., or than -20° C.).

The heating can also be carried out, at least partially, indeed even entirely, by means of an auxiliary heating element, for example an electrical resistance heater. The auxiliary heating element can be fitted to the battery.

It is thus possible to dedicate the heat-transfer composition according to the invention only to the uniform cooling of the battery, whereas other means, for example an electrical resistance heater, are used for heating it.

Alternatively, it is possible to provide a heating element associated with the main circuit, in particular upstream of the battery. In this case, the heating element is capable of heating the heat-transfer composition, which subsequently heats the battery.

The term “temperature of the battery” generally means the temperature of an outer wall of one or more of its electrochemical cells.

The temperature of the battery can be measured by means of a temperature sensor. If several temperature sensors are present at the battery, the temperature of the battery can be regarded as being the mean of the various temperatures measured. The invention makes it possible to considerably reduce the difference between the temperatures measured at different points of the battery.

Regulation of the temperature can be carried out when the battery of the vehicle is being charged. Alternatively, it can be carried out when the battery is being discharged, in particular when the motor of the vehicle is switched on. It notably prevents the battery temperature from becoming excessive, on account of the outside temperature and/or on account of the intrinsic heating of said battery when it is functioning.

In particular, the charging of the battery can be fast charging. Thus, during the complete charging of the battery (from a moment when the battery is completely discharged) over a period of less than or equal to 30 minutes, and preferably less than or equal to 15 minutes, the use of the composition according to the invention makes it possible to keep the temperature of the battery within an optimum temperature range with a uniform distribution. This is advantageous given that, during fast charging, the battery tends to heat up rapidly and to reach high temperatures with in particular hot spots which can degrade its operation, its performance, its safety and its lifespan.

In certain embodiments, the cooling of the battery is continuous over a certain period of time.

In certain embodiments, the cooling and optionally the heating allow the battery temperature to be maintained within an optimum temperature range, in particular when the vehicle is in operation (motor switched on), and notably when the vehicle is moving. This is because, if the temperature of the battery is too low, the performance of the latter is liable to decrease significantly.

In certain embodiments, the vehicle battery temperature can thus be maintained between a minimum temperature t₁ and a maximum temperature t₂.

In certain embodiments, the minimum temperature t₁ is greater than or equal to 10° C. and the maximum temperature t₂ is less than or equal to 80° C., preferably the minimum temperature t₁ is greater than or equal to 15° C. and the maximum temperature t₂ is less than or equal to 70° C., and more preferably the minimum temperature t₁ is greater than or equal to 16° C. and the maximum temperature t₂ is less than or equal to 50° C. For example, t₁ can be equal to 20° C. (indeed even greater than 20° C.) and t₂ can be equal to 40° C. (indeed even less than 40° C.).

A feedback loop is advantageously present to modify the operating parameters of the unit as a function of the battery temperature that is measured, so as to ensure the desired temperature maintenance.

The outside temperature during the period of maintaining the vehicle battery temperature between the minimum temperature t₁ and the maximum temperature t₂ can in particular be from -60° C. to -50° C.; or from -50° C. to -40° C.; or from -40° C. to -30° C.; or from -30° C. to -20° C.; or from -20° C. to -10° C.; or from -10° C. to 0° C.; or from 0° C. to 10° C.; or from 10° C. to 20° C.; or from 20° C. to 30° C.; or from 30° C. to 40° C.; or from 40° C. to 50° C.; or from 50° C. to 60° C.; or from 60° C. to 70° C.

The term “outside temperature” means the ambient temperature outside the vehicle before and during the maintaining of the vehicle battery temperature between the minimum temperature t₁ and the maximum temperature t₂.

The invention also relates to the use of the heat-transfer composition described above to prevent, to delay or to limit the consequences of the runaway of the battery following a failure (for example a short circuit). The presence of a runaway is characterized by an uncontrolled increase in the temperature accompanied by a rapid generation of gas caused predominantly by the decomposition of the electrolyte, at a typical temperature of 150° C. to 200° C., resulting in the formation of CO, CO₂, HF and flammable entities, such as H₂, CH₄, C₂H₄, C₂H₆, C₂H₅F. The content of flammable gases can reach at least 30% in the ejected gases.

Thus, the heat-transfer composition described above can be used to maintain the battery temperature at less than 150° C., preferably at less than 140° C., more preferably at less 140° C., more preferably at less than 130° C., in the event of failure.

The heat-transfer composition described above can also be used to reduce or suppress the flammability of the gas mixture ejected in the event of runaway of the battery. In particular, it can be used to ensure that the content of flammable gases in the ejected gas mixture remains relatively low. It can be used to ensure that the content of refrigerant in the ejected gas mixture is greater than or equal to 30 mol%, preferably greater than or equal to 40 mol%, or greater than or equal to 50 mol%, or greater than or equal to 60 mol%, or greater than or equal to 70 mol%; in this embodiment, this refrigerant is chosen to be nonflammable, that is to say of class A1 in the ASHRAE 34 standard; preferably, the refrigerant comprises or consists of HCFO-1233zdE.

### EXAMPLES

### Example 1 - Miscibility and Dielectric Properties

Compositions were prepared by combining HCFO-1233zdE as refrigerant with a mixture of benzyltoluene and dibenzyltoluene (sold by Arkema under the name Jarylec® C101). It was first confirmed that the two products were miscible in all proportions.

The oil was introduced by weighing out in a 0.2 I autoclave equipped with a magnetic stirrer and a jacket in which a heat-transfer fluid flows so as to homogenize the temperature in the gas phase and the liquid phase.

The autoclave was then cooled to -10° C., at which point the vacuum was drawn.

The HCFO-1233zdE contained in a cylinder was transferred in closed circuit mode as a liquid phase by weighing out.

The minimum volume of liquid charged was calculated in order for the composition of the liquid phase not to vary as a function of the temperature.

The final mixture was brought to the desired temperature with stirring so as to homogenize it. The stirring was then switched off until the mixture reached equilibrium. The temperature and pressure were recorded at equilibrium.

FIG. 5 shows the influence of the content of refrigerant on the liquid saturation temperature of the composition at a saturation vapor pressure of 1 bar. More particularly, it is seen that, relative to a composition comprising 100% oil, the addition of refrigerant to the composition, even in a low content, makes it possible to significantly reduce the liquid saturation temperature of the composition, thus making it possible to increase the battery cooling capacity.

A composition was prepared by mixing 69.2 g of HCFO-1233zd E and 100.5 g of Jarylec® C101 from Arkema under the conditions presented below.

TABLE 1

| T autoclave (°C.) | Pressure (bar abs) | Observations |
|---|---|---|
| 20 | 0.71 | miscible |
| 60 | 2.5 | miscible |

Another composition was prepared by mixing 35% by weight of HCFO-1233zdE and 65% by weight of Jarylec® C101, from Arkema, under the conditions presented below.

The breakdown voltage was measured according to the standard IEC 60159:1995.

TABLE 2

| Jarylec® C101 (weight %) | R1233zd E (weight %) | Resistivity at 10° C. | Breakdown voltage at 20° C. (kV) |
|---|---|---|---|
| 100 | 0 | 3.12 × 10¹³ | 90 |
| 65 | 35 | 1.50 × 10¹² | 69.7 |
| 0 | 100 | 1.56 × 10¹⁰ | 47.3 |

### Example 2 - Viscosity

Viscosity measurements were performed in an autoclave reactor having a jacket in which a heat-transfer fluid flows and having a capacity of 0.2 L, into which reactor the oil Jarylec® C101 was introduced. The reactor was cooled to -10° C. and magnetically stirred. Then HCFO-1233zdE was introduced by pressure difference. The reactor was then brought to the measurement temperature.

The viscosity was then measured with a vibrating-rod viscometer, model MIVI 9601 from Sofraser. A camera was used to confirm the miscibility of the oil and the refrigerant under the conditions of the measurement and to check the immersion of the viscometer rod, before taking the measurement.

TABLE 3

| | | | | |
|---|---|---|---|---|
| Content of HCFO-1233zdE | 0% | 10% | 0% | 10% |
| T (°C.) | 20 | 20 | 0 | 0 |
| Dynamic viscosity (cP) | 6.0 | 3.9 | 12 | 6.5 |

For comparative purposes, a viscosity measurement according to the standard ISO 3104 was performed on the oil (0% HCFO-1233zdE) at 20° C. The value obtained is 6.5 cP.

### Example 3 - Flammability

A flash point measurement was performed on a composition containing 90% by weight of Jarylec® C101 oil and 10% by weight of HCFO-1233zdE, and also on a comparative composition containing 100% by weight of Jarylec® C101 oil.

The mixture was prepared at low temperature, under atmospheric pressure. It is homogeneous and liquid at ambient temperature and atmospheric pressure.

The flash point measurement was performed according to the standard ISO 3679 or ISO3680, “Determination of flash/no flash - Rapid equilibrium closed cup method”. The standardized tests are performed with the filling port left free, thus open and venting to the atmosphere, with the cup closed.

The tests were adapted on a case-by-case basis by blocking the filling port so as to simulate an even more confined device during temperature equilibrium (2 minutes under standardized conditions). In this case, the tests are performed with the “lid blocked”.

The temperature range explored goes up to 300° C.

TABLE 4

| | | |
|---|---|---|
| Content of HCFO-1233zd E | 0% | 10% |
| Flash point | 138° C. | Not detected |

### Example 4 - Heat Transfer Coefficient

In order to make comparative heat transfer coefficient measurements, a test device is used comprising a module of 36 prismatic cells (one real lithium titanate cell surrounded by 35 dummy cells) in a hermetic housing. The cells and the busbar are immersed in a liquid circulating at a rate of from 0.5 I/min to 40 I/min. The liquid inlet and outlet temperatures, the flow rate and the pressure are measured and monitored. The liquid is cooled externally.

The cells are cooled on their small surfaces. The liquid passages are arranged in parallel. The module is equipped with 26 temperature sensors, eight of which are distributed on one of the large surfaces of the real cell.

The tests were performed at different heat flux densities F between 0 and 1 W/cm². F is equal to the total thermal power supplied divided by the total exchange area.

The liquid tested was either an oil with a viscosity similar to that of Jarylec® C101 or a mixture of this oil with HCFO-1233zdE. The HCFO-1233zdE was first introduced while avoiding any introduction of moisture or of air pollution. The oil was added by gravity using a graduated cylinder. The miscibility and homogeneity were checked by sampling.

The device was used in automatic test mode, with a heat flux density F of 0.25 W/cm² (adjusted by varying the power supplied) and an average fluid temperature of 15° C. (average of the liquid temperature at the housing inlet and the liquid temperature at the housing outlet). For a given heat flux density, the liquid flow rate was increased up to the maximum pumping speed, which depends on the fluid.

The heat transfer coefficient H corresponds to the heat flux density divided by the difference between the average cell temperature and the fluid temperature at the housing inlet.

TABLE 5

| HCFO-1233zdE (weight %) | Liquid flow rate (I/min) | H W/(m².K) |
|---|---|---|
| 10 | 15 | 146 |
| 0 | 15 | 152 |
| 10 | 18 | 167 |

With the pure oil, the maximum liquid flow rate that can be achieved is 15 I/min. With the composition comprising 10% HCFO-1233zdE, the maximum liquid flow rate that can be achieved is 18 I/min.

### Example 5 - Prevention of Runaway

A test was carried out in a compact assembly of 8 energy storage cells, housed in a sealed enclosure filled with a fluid A (pure HCFO-1233zdE) or with a fluid B (10% of HCFO-1233zdE + 90% of dielectric oil based on aliphatic hydrocarbon, by weight). The enclosure is equipped with a valve calibrated for a pressure greater than the vapor pressure of the fluid at 50° C.

The test is equipped with thermocouples for monitoring the temperatures of the wall of the cells and of the fluid. The ejected gases are analyzed by gas chromatography after washing to remove the acid products.

The characteristics of the cells are as follows:
Model: Samsung INR 18650 35E.
Electrical architecture: 1s8p.
Capacity: 3.5 A.h.
Chemistry: LiNiCoMnO₂.
Voltage: 2.5 V minimum, 3.6 V nominal, 4.2 V maximum.

At time t = 0, a short circuit is created on one of the cells charged to the maximum by means of a nail. The cell concerned then undergoes thermal runaway, which is reflected by an increase in the temperature and pressure and an opening of the valve of the enclosure.

In the case of the fluid A, the calibration pressure of the valve is 4 bar absolute. The maximum average temperature is 93° C., and the average temperature after 300 s is 63° C. The content of HCFO-1233zd in the ejected gases is greater than 60 mol%. The content of H₂ is 9 mol%. The runaway is not propagated to the other cells, which remain intact.

Analysis of the gases does not reveal any degradation of the HCFO-1233zd.

In the case of the fluid B, the calibration pressure of the valve is 1.5 bar absolute. The maximum average temperature is 128° C., and the average temperature after 300 s is 73° C. The content of HCFO-1233zd in the ejected gases is greater than 50 mol%. The content of H₂ is 11 mol%. The runaway is not propagated to the other cells, which remain intact. Analysis of the gases does not reveal any degradation of the HCFO-1233zd, nor any reaction with the oil.

The complete temperature profile can be seen in FIG. 6.

1. The use of a heat-transfer composition comprising from more than 0% to 40% by weight of a refrigerant comprising a compound chosen from halogenated hydrocarbons, perhalogenated compounds, fluorinated ketones, fluorinated ethers and the combinations thereof, and from 60% to less than 100% by weight of a dielectric fluid, for regulating the temperature of a battery, the battery comprising energy storage cells immersed in the heat-transfer composition in the liquid state, and the heat-transfer composition undergoing essentially no change of state.

2. The use as claimed in claim 1, wherein the heat-transfer composition circulates in a heat-transfer circuit.

3. The use as claimed in claim 2, wherein the battery comprises one or more modules each comprising an enclosure in which energy storage cells are arranged, the enclosure(s) forming part of the heat-transfer circuit.

4. The use as claimed in claim 2, wherein the heat-transfer circuit is thermally coupled to a secondary circuit containing an additional transfer composition.

5. The use as claimed in claim 4, wherein the secondary circuit is the air conditioning circuit of a vehicle; and/or is a reversible heat pump circuit.

6. The use as claimed in claim 1, wherein the refrigerant comprises or is 1-chloro-3,3,3-trifluoropropene, or is a binary mixture of 1-chloro-3,3,3-trifluoropropene in Z form and of 1,1,1,2,3-pentafluoropropane, or of 1,1,1,4,4,4-hexafluorobut-2-ene in Z form and of 1,2-dichloroethylene in E form.

7. The use as claimed in claim 1, wherein the dielectric fluid is chosen from mineral dielectric oils, synthetic dielectric oils and vegetable dielectric oils.

8. The use as claimed in claim 1, for the cooling of the battery.

9. The use as claimed in claim 1, wherein the battery is the battery of an electric or hybrid vehicle.

10. The use as claimed in claim 9, implemented during the charging of the battery of the vehicle.

11. A battery assembly, in particular for an electric or hybrid vehicle, comprising one or more modules each comprising an enclosure arranged in which are energy storage cells immersed in a heat-transfer composition in the liquid state, the heat-transfer composition comprising from more than 0% to 40% by weight of a refrigerant comprising a compound chosen from halogenated hydrocarbons, perhalogenated compounds, fluorinated ketones, fluorinated ethers and the combinations thereof, and from 60% to less than 100% by weight of a dielectric fluid, and the battery assembly being configured so that the heat-transfer composition undergoes essentially no change of state in order to regulate the temperature of the battery.

12. The battery assembly as claimed in claim 11, comprising a heat-transfer circuit wherein the heat-transfer composition circulates, the enclosure(s) of the module(s) being incorporated in this heat-transfer circuit.

13. The battery assembly as claimed in claim 12, wherein the heat-transfer circuit comprises a pump; and/or wherein the heat-transfer circuit comprises a heat exchanger in order to enable a heat exchange between the heat-transfer composition and either the ambient air or a heat-transfer composition in a secondary circuit.

14. The battery assembly as claimed in claim 11, wherein the refrigerant comprises or is 1-chloro-3,3,3-trifluoropropene, or is a binary mixture of 1-chloro-3,3,3-trifluoropropene in Z form and of 1,1,1,2,3-pentafluoropropane, or of 1,1,1,4,4,4-hexafluorobut-2-ene in Z form and of 1,2-dichloroethylene in E form.

15. The battery assembly as claimed in claim 11, wherein the dielectric fluid is chosen from mineral dielectric oils, synthetic dielectric oils and vegetable dielectric oils.

16. A method for regulating the temperature of the battery of the battery assembly as claimed in claim 11, comprising the heating of the energy storage cells by the heat-transfer composition and/or the cooling of the energy storage cells by the heat-transfer composition, essentially without change of state of the heat-transfer composition.
